(19) United States
(12) Patent Application Publication
(10) Pub. No.: US 2006/0100024 A1
(43) Pub. Date: May 11, 2006

(54) Transmission shaft for a hand tool or a power tool

(76) Inventor: Ming-Ta Cheng, Miaoli Hsien (TW)

Correspondence Address: BACON & THOMAS, PLLC, 625 SLATERS LANE, FOURTH FLOOR, ALEXANDRIA, VA, 22314, US

(21) Appl. No.: 10/981,575

(22) Filed: Nov. 5, 2004

(51) Int. Cl. F16C 3/00

(52) U.S. Cl. 464/179

(57) ABSTRACT

A transmission shaft has a proximal end, a distal end, a socket, a locking element, an outer surface and a driving part. The proximal end is mounted securely in a hand tool or a power tool. The socket is formed in the distal end and a tool head is mounted securely in the socket. The locking element is mounted in the socket to secure the tool head. The driving part is formed on the outer surface near the distal end and a sleeve is mounted securely around the driving part. The transmission shaft can be mounted with the tool head by the socket and be mounted with the sleeve by the driving part.

### BACKGROUND OF THE INVENTION

1. Field of the Invention

The present invention relates to a transmission shaft, especially to a transmission shaft that can be mounted with a tool head or a sleeve.

2. Description of the Prior Arts

With reference to FIG. 7, one of the conventional transmission shafts for a power tool (40) is solid and a sleeve (41) is drivingly mounted around the conventional shaft (40).

With reference to FIG. 8, another of the conventional transmission shafts (50) for a power tool is hollow and a tool head (51) is mounted in the conventional transmission shaft (50).

Those two kinds of conventional transmission shafts (40, 50) as described can only be mounted with a sleeve or a tool head.

With reference to FIG. 9, yet a further conventional transmission shaft (60) can be mounted with a sleeve and a tool head. The conventional transmission shaft (60) has a polygonal end (61), an extending end (62), a socket (63), a C-clip (64) and a ball (65). The socket (63) is formed in the extending end (62). The C-clip (64) is mounted around the extending end (62) and presses the ball (65) into the socket (63). A sleeve is mounted securely around the polygon end (61). A tool head is mounted in the socket (63) and presses against the ball (65). Although the conventional transmission shaft (60) can be mounted a sleeve and a tool head, the conventional shaft (60) still has some disadvantages:

1. Because of the extending end (62), the length of the transmission shaft (60) is particularly long and is too cumbersome. 2. Because the socket (63) is formed in the extending end (62) and the C-clip (64) presses the ball (65) into the socket (63), the extending end (62) is thin and has a through hole. When the transmission shaft (60) is used on a power tool, the extending end (62) is easily broken.

3. The C-clip (64) is difficult to manufacture and accordingly the unit cost is high. The transmission shaft (60) is also difficult to manufacture the C-clip (64) corresponding to the transmission shaft (60) and the C-clip (64) is difficult to mount on the transmission shaft (60).

To overcome the shortcomings, the present invention provides an improved transmission shaft to mitigate or obviate the aforementioned problems.

### SUMMARY OF THE INVENTION

The main objective of the present invention is to provide a transmission shaft that can be mounted with a sleeve and a tool head, is not easily broken and is easy to be made.

A transmission shaft has a proximal end, a distal end, a socket, a locking element, an outer surface and a driving part. The proximal end is mounted securely in a hand tool or a power tool. The socket is formed in the distal end and a tool head is mounted securely in the socket. The locking element is mounted in the socket to secure the tool head. The driving part is formed on the outer surface near the distal end and a sleeve is mounted securely around the driving part. The transmission shaft can be mounted with the tool head by the socket and mounts the sleeve by the driving part.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a transmission shaft in accordance with the present invention with a power tool;

FIG. 2 is a perspective view in partial section of the first embodiment of the transmission shaft in FIG. 1 with a sleeve;

FIG. 3 is a perspective view in partial section of the first embodiment of the transmission shaft in FIG. 1 with a hexagonal wrench;

FIG. 4 is a perspective view in partial section of the first embodiment of the transmission shaft in FIG. 1 with a tool head;

FIG. 5 is a front view in partial section of a second embodiment of a transmission shaft in accordance with the present invention with a ratchet wrench;

FIG. 6 is a front view in partial section of a third embodiment of a transmission shaft in accordance with the present invention with the second embodiment of the transmission shaft in FIG. 5 and the ratchet wrench;

FIG. 7 is an exploded perspective view of a conventional transmission shaft with a power tool and a sleeve;

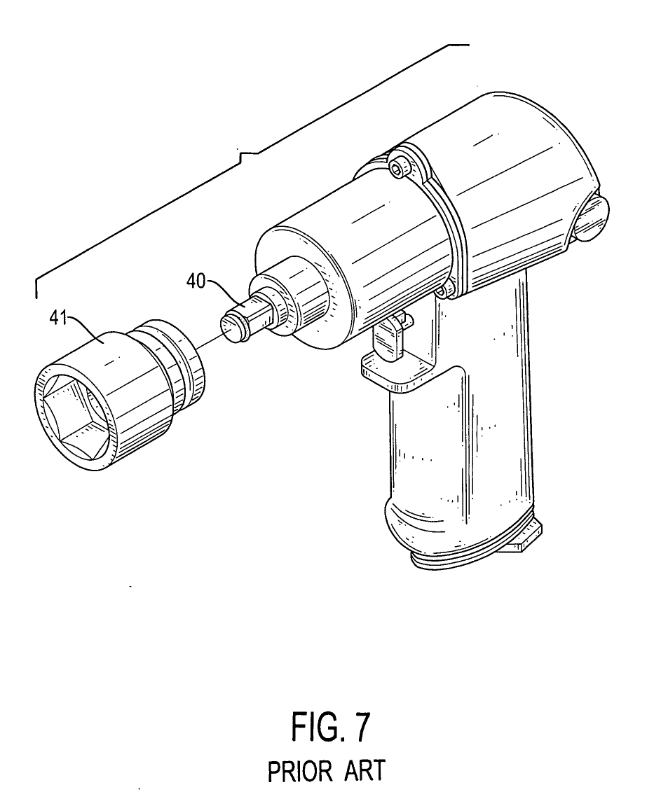

FIG. 8 is an exploded perspective view of another conventional transmission shaft with a hand tool and a tool head; and

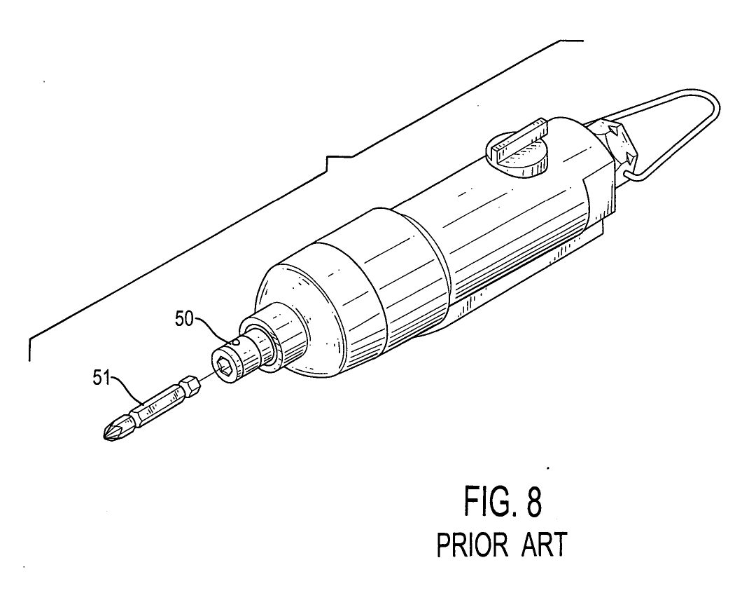

FIG. 9 is an exploded perspective view of yet another conventional transmission shaft with a power tool.

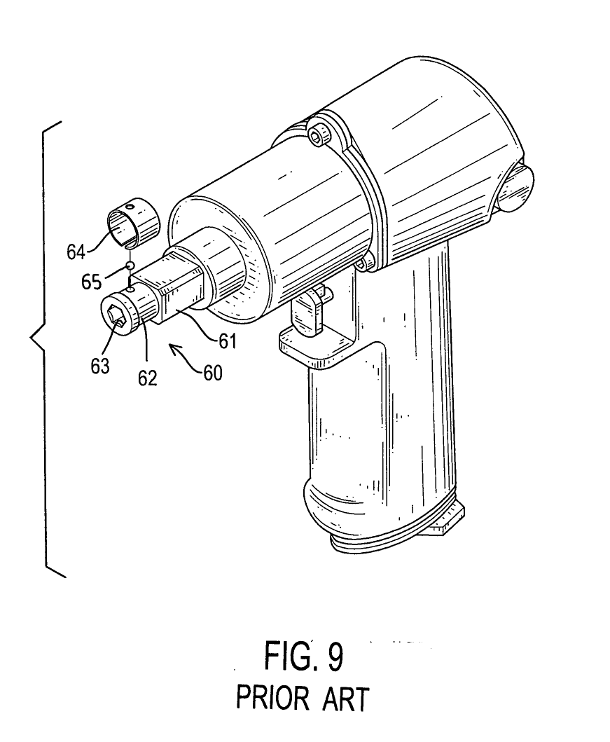

### DETAILED DESCRIPTION OF THE PREFERRED EMBODIMENTS

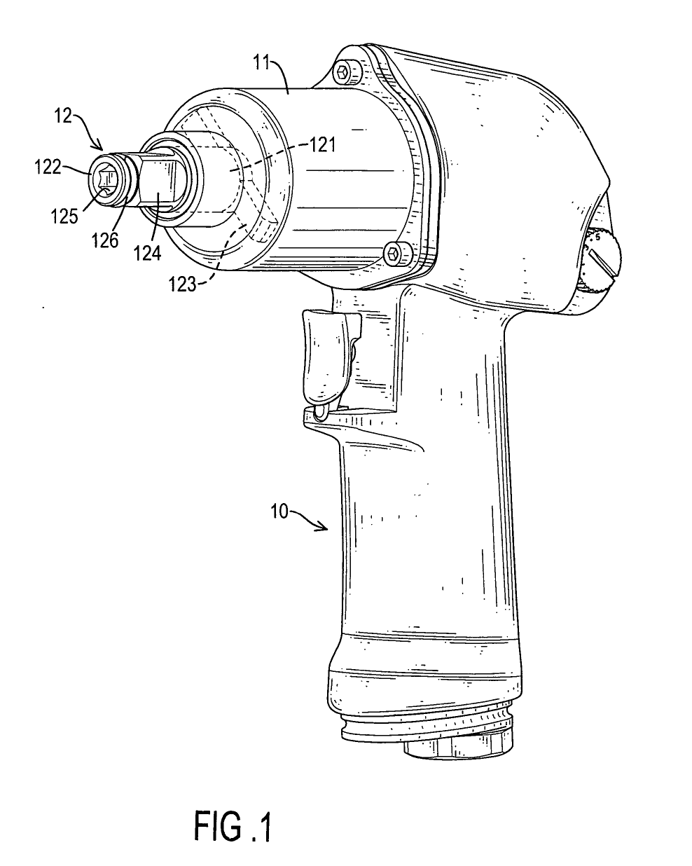

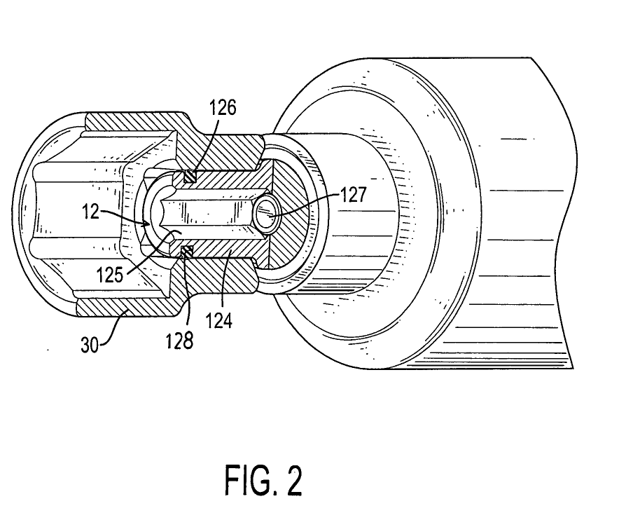

With reference to FIGS. 1 and 2, a power tool (10) has an actuating end (11). The first embodiment of a transmission shaft (12) in accordance with the present invention comprises a proximal end (121), an optional positioning element, a distal end (122), a socket (125), a locking element, an outer surface, a driving part (124), an optional mounting recess (128) and an optional C-clip (126). The proximal end (121) is mounted securely in the actuating end (11) of the power tool (10). The positioning element is formed on the proximal end (121) to secure the proximal end (121) in the actuating end (11) of the power tool (10) and may be a pair of wings (123). The socket (125) is formed in the distal end (122), has a bottom and may be polygonal. The locking element is mounted in the socket (125), may be attached to the bottom of the socket (125) and may be a magnetic element (127). The driving part (124) is formed on the outer surface near the distal end (122) and may be polygonal. In the preferred embodiment, the driving part (124) is quadrilateral. The mounting recess (128) is formed around the outer surface between the distal end (122) and the driving part (124). The C-clip (126) attaches to the mounting recess (128).

A sleeve (30) is mounted securely around the driving part (124) of the transmission shaft (12) and has an inner surface. The inner surface of the sleeve (30) corresponds to the driving part (124). The inner surface of the sleeve (30) attaches to the C-clip (126) and C-clip (126) bends out and presses against the inner surface of the sleeve (30) to secure the sleeve (30) to the driving part (124).

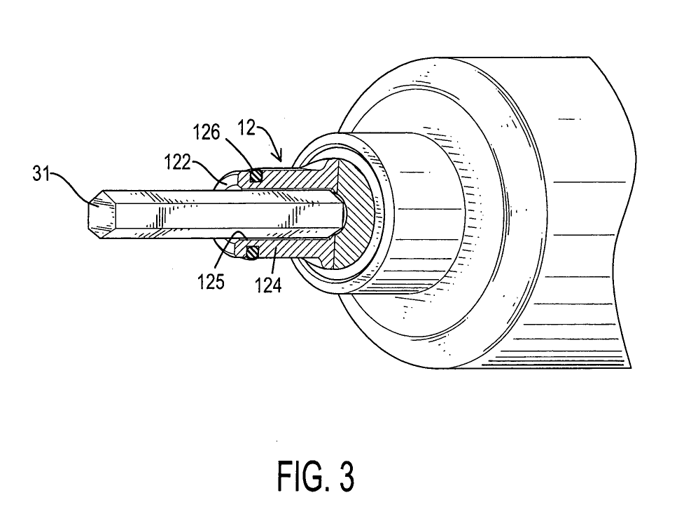

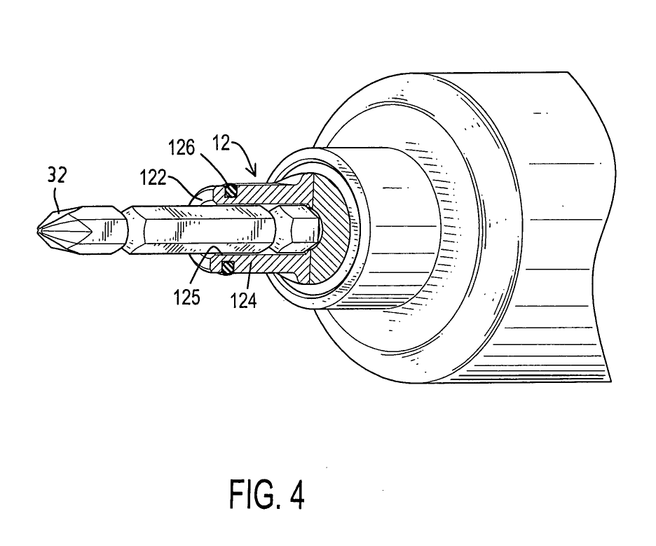

With further reference to FIGS. 3 and 4, a tool head (31, 32) is mounted securely in socket (125). The locking element in the socket (125) locks and secures the tool head (31, 32).

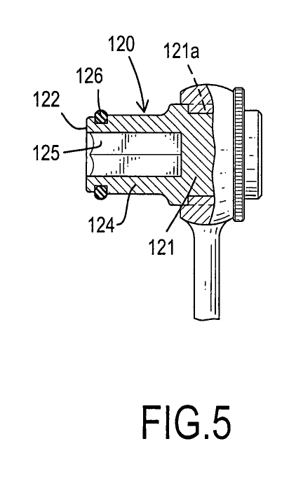

With further reference to FIG. 5, the second embodiment of a transmission shaft (120) in accordance with the present invention further comprises a ratchet (121a). The ratchet (121a) is formed on the outer surface near the proximal end (121) and engages in a ratchet wrench (20).

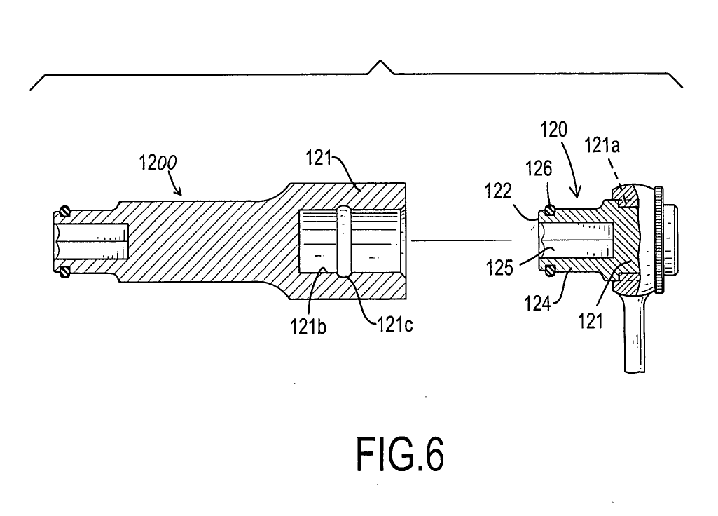

With further reference to FIG. 6, the third embodiment of a transmission shaft (1200) in accordance with the present invention further comprises a receiving socket (121b) and a locking recess (121c). The receiving socket (121b) is formed in the proximal end (121) and mounted securely around the distal end (121) of the transmission shaft (120). The locking recess (121c) is formed in the receiving socket (121b) and presses against the C-clip (126) to secure the transmission shaft (1200). Using the third embodiment of the transmission shaft (1200) mounted around the second embodiment of the transmission shaft (120) can extend the length of the transmission shaft.

The transmission shaft as described has numerous advantages. Because the driving part (124) is formed near the distal end (122), the full length of the transmission shaft will not be inconveniently long. Because the C-clip (126) attaches to the mounting recess (128) and the mounting recess (128) is not formed through the transmission shaft, the transmission shaft will not be too thin and correspondingly will not be broken easily. The transmission shaft is easy to be made and can be mounted with a sleeve and a tool head.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A transmission shaft comprising
a proximal end;
a distal end;
a socket formed in the distal end and having a bottom;
a locking element mounted in the socket to secure the tool head;
an outer surface; and
a driving part formed on the outer surface near the distal end.

2. The transmission shaft as claimed in claim 1 further comprising a positioning element formed on the proximal end.

3. The transmission shaft as claimed in claim 2, wherein the positioning element is a pair of wings.

4. The transmission shaft as claimed in claim 1, wherein the socket is polygonal.

5. The transmission shaft as claimed in claim 1, wherein the locking element is attached to the bottom of the socket.

6. The transmission shaft as claimed in claim 5, wherein the locking element is a magnetic element.

7. The transmission shaft as claimed in claim 1, wherein the driving part is polygonal.

8. The transmission shaft as claimed in claim 7, wherein the driving part is quadrilateral.

9. The transmission shaft as claimed in claim 1 further comprising
a mounting recess formed around the outer surface between the distal end and the driving part; and
a C-clip clamping the mounting recess.

10. The transmission shaft as claimed in claim 1 further comprising a receiving socket formed in the proximal end.

11. The transmission shaft as claimed in claim 10 further comprising a locking recess formed in the receiving socket.
